(19) United States
(12) Patent Application Publication
(10) Pub. No.: US 2008/0222277 A1
(43) Pub. Date: Sep. 11, 2008

(54) Method and Apparatus for Configuring and Managing a Robust Overlay Multicast Tree

(76) Inventors: Ju Young Park, Daejeon (KR); Eun Sook Kim, Daejeon (KR); Ei Yeon Kwon, Daejeon (KR); Shin Gak Kang, Daejeon (KR); Ok Jo Jeong, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/577,381

(22) PCT Filed: Nov. 4, 2005
(86) PCT No.: PCT/KR05/03708

§ 371 Date: Apr. 17, 2007

(30) Foreign Application Priority Data
Nov. 6, 2004 (KR) 10-2004-0090112
Oct. 28, 2005 (KR) 10-2005-0102155

(51) Int. Cl. G06F 15/16

(52) U.S. Cl. 709/223

(57) ABSTRACT

Provided is a method and apparatus for configuring and managing an overlay multicast data delivery tree in a transmission network having a SM (session manager) and at least one MA (multicast agent). The method includes the steps of at the MA intending to joining a session, obtaining an active neighbor MA list from the SM; detecting information on QoS information of each neighbor MA in the active neighbor MA list, selecting a MA having the most optimized QoS as a parent MA based on the QoS information of each Neighbor MA in the active neighbor MA list, joining an overlay multicast data communication session through the selected parent MA, periodically receiving HB (heart beat) information having information on a path from a root to the MA and determining whether to perform a parent-switching based on me HB information and parent-switching from the current parent MA to a MA having a better QoS when it is determined to perform the parent-switching

### TECHNICAL FIELD

The present invention relates to a method and apparatus for effectively configuring and managing a 1:N data delivery tree in an overlay multicast environment, and more particularly, to a method and apparatus for effectively configuring and managing a 1:N overlay multicast data delivery tree through an end host or server to provide a service of 1:N group data transmission.

### BACKGROUND ART

Internet transmission methods may be classified into a unicast method in which one sender transmits data to another receiver, a broadcast mechanism in which one sender transmits data to all receivers on the same sub network, and a multicast mechanism in which at least one sender each transmits data to at least one specific receiver, in the light of a sender and a receiver taking part in transmission.

In the multicast mechanism, all resources and bandwidths of a node can be effectively used when the sender simultaneously transmits the same data to a plurality of receivers. The multicast mechanism is a mechanism suitable for transmitting application data in group communications but until now, a multicast technology (or IP multicast) in an Internet environment can be partially employed only in a test bed or some of an intra network, a school network, or a test network. The reason why the multicast technology is not completely supported can be exemplified as a problem regarding a cost taken to replace all routers currently provided on an Internet network with multicast enabled routers, an address assignment problem, and a technical problem regarding a multicast routing protocol and a hardware state management mechanism.

As an example of a problematic load of an IP multicast router, heavy load is applied to a current IP multicast backbone router in managing a routing table for members frequently subscribing to/leaving from a group. However, unlike a unicast fixed IP network, an actual IP multicast network is a dynamic network frequently varying depending on initiation and termination of an application. That is, in the IP multicast network, an application program subscribes to a known session (a group address, a port number, and contents), thereby creating a data communication path.

Accordingly, in recent years, an overlay multicast mechanism has been proposed where multicast is possible using application layer programs without changing existing Internet equipments. The overlay multicast mechanism refers to a kind of a technology of overlay multicast transmission where several agents are installed at a present unicast-based Internet, and the related sender/receiver and agents are configured in a tree structure so that the sender can transmit multicast data to a group of receivers using the agent relay function. In the overlay multicast transmission mechanism, connection is made by tunneling through a virtual multicast router in a non-multicast area where a multicast router is directly not connected to a multicast backbone, thereby allowing IP multicast between the sender and the receiver.

Korean Patent No. 2002-68477 entitled “Method for configuring and managing Internet-based overlay multicast tree”, discloses a method for configuring the overlay multicast tree in a unicast environment, using an end host or server.

However, the overlay multicast method has a disadvantage in that because each element is comprised of application programs at end hosts, not network equipments, it is very difficult to build an overlay multicast environment similar with the topology of a physical network. In an overlay multicast network, inter-node distances or network status can be measured only through a dispersion method and a link is generated between end hosts, not a router as the network equipment, and therefore, a network topology can be frequently changed as a new node frequently subscribe/leave. In other words, there is a drawback in that a physical network environment cannot be considered upon establishment of the transmission path in the overlay multicast environment, thereby causing ineffectiveness, and frequent subscript ion/leaving of end nodes (hosts) may cause frequent error.

### DISCLOSURE

### Technical Problem

The present invention is directed to a method and apparatus for effectively configuring and managing a multicast data delivery tree in an overlay multicast environment.

The present invention is also directed to a method and apparatus for configuring, continuously managing and improving a multicast data delivery tree in an overlay multicast environment, and, when an error occurs, detecting and recovering immediately.

### Technical Solution

One aspect of the present invention is to provide a method for configuring and managing an overlay multicast data delivery tree in a transmission network having a SM (session manager) and at least one MA (multicast agent). The method comprises the steps of: at the MA intending to joining a session, (a) obtaining an active neighbor MA list from the SM; (b) detecting information on QoS information of each neighbor MA in the active neighbor MA list; (c) selecting a MA having the most optimized QoS as a parent MA based on the QoS information of each neighbor MA in the active neighbor MA list; (d) joining an overlay multicast data communication session through the selected parent MA; (e) periodically receiving HB (heart beat) information having information on a path from a root to the MA, and determining whether to perform a parent-switching based on the HB information; and (f) parent-switching from the current parent MA to a MA having a better QoS when it is determined to perform the parent-switching.

Another aspect of the present invention is to provide a method for configuring and managing an overlay multicast data delivery tree in a transmission network having a session manager (SM) and at least one multicast agent (MA), the method may include the steps of: at the SM, storing a list of active MAs having joined a session managed by the SM and being currently in a normal operation, and a list of ready MAs not yet confirmed whether to normally operate in the session; receiving a subscription request message from a MA intending to joining the session; determining whether to permit subscription of the MA, in response to the received subscription request message; when it is determined that session subscription is permitted, extracting a portion of the active MA list, and transmitting a subscription answer message having the extracted portion of the active MA list to the MA; when it is determined that the session subscription is rejected, transmitting a subscription answer message having a rejection reason to the MA; and adding the MA information to the ready MA list.

Another aspect of the present invention is to provide a multicast agent apparatus including: means for obtaining an active, neighbor MA list from a SM; means for detecting QoS information of each neighbor MA in the active neighbor MA list; means for selecting a MA having the most optimized QoS as a parent MA based on the QoS information of each the neighbor MA, and joining an overlay multicast data communication session through the selected parent MA; means for periodically receiving HB information having information on a path from a root to the MA, and determining whether to perform a parent switching based on the received HB information; and means for parent-switching from the current parent MA to a MA having a better QoS when it is determined to perform the parent-switching.

Another aspect of the present invention is to provide a session manager apparatus comprising: means for storing a list of active MAs having joined a session managed by itself and being currently in a normal operation, and a list of ready MAs not yet confirmed whether normally operating in the session, and periodically updating the lists; means for receiving a subscription request message from a MA intending to joining the session, and determining whether permitting subscription of the MA in response to the subscription request message; means for extracting a portion of the active MA list and transmitting to the MA a subscription answer message having the extracted portion of the active MA list, when it is determined to permit session subscription, and transmitting to the MA a subscription answer message having a rejection reason, when it is determined to reject the session subscription; and means for adding the MA information to the ready MA list.

### Advantageous Effects

As described above, according to the present invention, it is possible to establish a robust and effective data transmission path depending on physical network topologies by establishing the overlay multicast data transmission path (tree) through the bootstrapping process of the initial MA and the map discovery process of searching for information on the neighbor MAs in the overlay multicast environment, and then performing the parent switching, continuous tree management and error recovery processes.

According to the present invention, it is possible to provide more effective service and higher quality of service in various group communications recently attracting attention only by installing software in a personal computer without any change of a current Internet infrastructure. In particular, it is possible to build a data transmission infrastructure irrespective of the number of simultaneous users even in the current Internet network environment by simply installing the program without change of a network environment.

While the invention has been shown and described with reference to certain exemplary embodiments thereof, it will be understood by those skilled in the art that various changes in form and details may be made therein without departing from the spirit and scope of the invention as defined by the appended claims.

### DESCRIPTION OF DRAWINGS

FIGS. 1A and 1B illustrate overlay multicast network environments according to the present invention;

FIG. 2 is a block diagram schematically illustrating main steps in a method for configuring and managing a multicast data delivery tree according to an embodiment of the present invention;

FIG. 3 is a flowchart illustrating a bootstrapping process of a multicast agent (MA) according to a preferred embodiment of the present invention;

FIG. 4 is a flowchart illustrating a bootstrapping process of a session manager (SM) according to an embodiment of the present invention;

FIG. 5 is a structure of a multicast agent (MA) list database (DB) which a SM maintains for membership management according to an embodiment of the present invention;

FIG. 6 illustrates a structure of a database (DB) which a MA maintains for membership management according to an embodiment of the present invention;

FIG. 7 is a flowchart illustrating a map discovery process according to an embodiment of the present invention;

FIG. 8 is a flowchart illustrating a parent switching (PS) process according to an embodiment of the present invention;

FIG. 9 is a flowchart in more detail illustrating a PS decision Step 840 of FIG. 8;

FIG. 10 is a flowchart in more detail illustrating a PS execution step 860 of FIG. 8;

FIG. 11 is an outline diagram illustrating a tree management operation of a SM according to an embodiment of the present invention;

FIG. 12 is an outline diagram illustrating a tree management operation of a MA according to an embodiment of the present invention;

FIG. 13 is an outline diagram illustrating a loop error recovery operation according to an embodiment of the present invention;

FIG. 14 is a flowchart in detail illustrating a loop recovery operation according to an embodiment of the present invention;

FIG. 15 is an outline diagram illustrating a network partitioning error recovery operation according lo an embodiment of the present invention; and

FIG. 16 is a flowchart in detail illustrating a network partitioning error recovery operation according to an embodiment of the present invention.

### MODE FOR INVENTION

Hereinafter, an exemplary embodiment of the present invention will be described in detail. However, the present invention is not limited to the embodiments disclosed below, but can be implemented in various types. Therefore, the present embodiment is provided for complete disclosure of the present invention and to fully inform the scope of the present invention to those ordinarily skilled in the art.

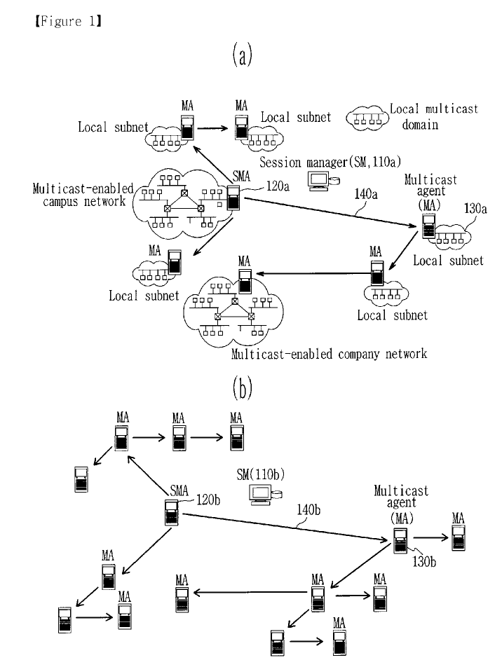

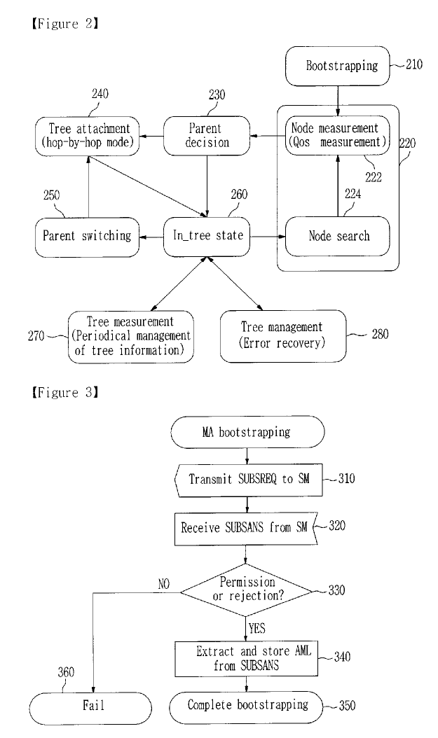

FIGS. 1A and 1B illustrate overlay multicast network environments according to the present invention. Specifically, FIG. 1A is a network environment for transmitting real-time multicast data, and FIG. 1B is a network environment for transmitting multicast data having a reliable characteristic such as stock data.

As shown in FIGS. 1A and 1B, the inventive overlay multicast network includes multicast agents (MAs) 120a, 130a, 120b, and 130b for performing relay transmission of the multicast data; and session managers (SMs) 110a and 110b for managing session information and processing a session subscription request from the multicast agent.

The multicast agent (MA) is present in each local subnet which users (nodes) desiring to communicate a specific group data belong to, and serves to transmit the multicast data. The multicast agent may be embodied as software, hardware, or a combination thereof in a personal computer, a server, or other types of data processing systems. In FIGS. 1A and 1B, the sender-side multicast agents (SMAs) 120a and 120b relay the multicast data, which is generated from a specific node of a subnet to which the SMAs belong, to the receiver-side multicast agents (MAs) 130a and 130b. Channels connecting between the SMAs 120a and 120b and the MAs 130a and 130b can be comprised of real-time/reliable unicast hop-by-hop channels 140a and 140b depending on a characteristic of data.

The session managers 110 and 110b manage session information for group communication, and upon receipt of the session subscription request from the multicast agent, determines whether to permit subscription, and upon permitting for the subscription, informs the corresponding multicast agent of a portion of an Active Multicast agent List (ML). In one embodiment, the session managers 110a and 110b can be embodied as software, hardware, or a combination thereof in an end host or a separate system.

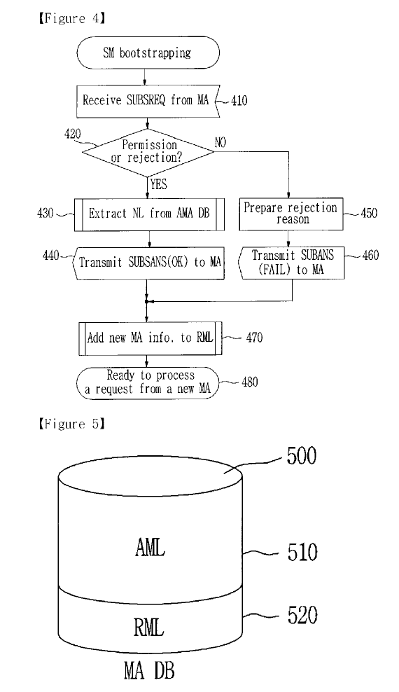

FIG. 2 is a block diagram schematically illustrating main steps in a method for configuring and managing a multicast data delivery tree according to an embodiment of the present invention.

As shown in FIG. 2, the present invention begins with a bootstrapping step 210 for allowing the multicast agent (MA) to join a session of an overlay network. In the bootstrapping step 210, the MA transmits a session subscription request message to the session manager (SM), and the SM, which receives it from the MA, determines whether to permit subscription of the MA. and upon permitting of the subscription, transmits a portion of the active MA list to the MA. The active MA list is a list of the MAs participating in the session and actively performing communication. The active Ms in the list increase in number as the session increases in size. Accordingly, when the session is large in size, the SM cannot provide its entire active MA list to the MAs. Thus, when the session is large in size, the SM extracts only a predetermined number of MAs from its entire active MA list, and transmits the extracted MA list to a new MA. The SM can extract, from its MA list, based on the criteria: 1) a high performance server, 2) a MA having a high transfer rate, and 3) a new MA in this order.

The MA joining the session performs a map discovery step 220 to obtain information on neighbor MAs. The map discovery step 220 includes a MA measuring step 222 for diagnosing a QOS (quality of service), such as a transmission delay to the neighbor MAs and a bandwidth, and a MA searching step 22A for searching for the neighbor MAs.

Next, the MA selects the most optimized neighbor MA as its parent MA in a parent decision step 230 and it requests the parent MA for data relay in a tree attachment step 240, resulting in an in_tree state in which communication is possible in Step 260. Thereafter, when a MA being capable of improving a current state is found, the current parent MA may be switched to such a new parent MA in a parent-switching step 250. The MA in the in_tree state continuously repeats the map discovery step 220 and the parent decision step 230, thereby continuously improving the overlay network. In Step 270, tree information may be periodically managed, and in Step 280, tree management may be performed to recover an error generated in the data delivery tree. Each of the steps will be now described in greater detail.

Bootstrapping (Step 210)

In the bootstrapping process, the MAs newly joining the session initially obtains information on the overlay multicast network. Hereinafter, the bootstrapping is separately described as the bootstrapping process of the multicast agent (MA) and the bootstrapping process of the session manager (SM).

FIG. 3 is a flowchart illustrating the bootstrapping process of the multicast agent (MA) according to a preferred embodiment of the present invention. The bootstrapping of the MA begins with transmission of a subscription request message (SUBSREQ) to the session manager (SM) in Step 310. A subscription answer message (SUBSANS) is received from the SM in response to the subscription request message in Step 320. Based on the subscription answer message, it is determined whether session subscription of the MA is permitted or rejected in Step 330. If the SM is determined to reject the subscription, the MA cannot join the session in Step 360. If the SM is determined to permit the subscription, the SM transmits the subscription answer message (SUBSANS) having a list of active neighbor MAs, which have been already joined the session, to the MA. The MA extracts and stores the active neighbor MA list in its local storage unit in Step 340, and terminates the bootstrapping in Step 350.

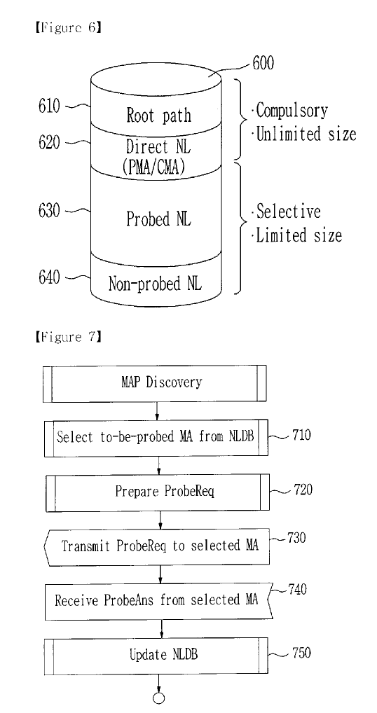

FIG. 4 is a flowchart illustrating the bootstrapping process of the session manager (SM) according to an embodiment of the present invention. The bootstrapping of the SM begins with receipt of a subscription request message from a new MA in Step 410. Through a control of reception, it is determined whether to permit or reject the subscription in Step 420. If it is determined to permit the subscription of the MA, the SM should inform the MS of bootstrapping information. To this end, the SM extracts some MAs from the Active Multicast agent List (AML) in its multicast agent database (MA_DB) in Step 430. Thereafter, the SM adds the extracted MA information to the subscription answer message (SUBSANS), and informs the MA of the subscription permission in Step 440.

If it is determined to reject the subscription of the new MA, a rejection reason of rejecting the subscription is prepared in Step 450, and the subscription answer message (SUBSANS) having the rejection reason is transmitted to the MA in Step 460.

The SM adds the newly joining MA information to a ready_MA_list (RML) of the MA_DB in Step 470, and prepares to receive a request from the newly joining MA in Step 480.

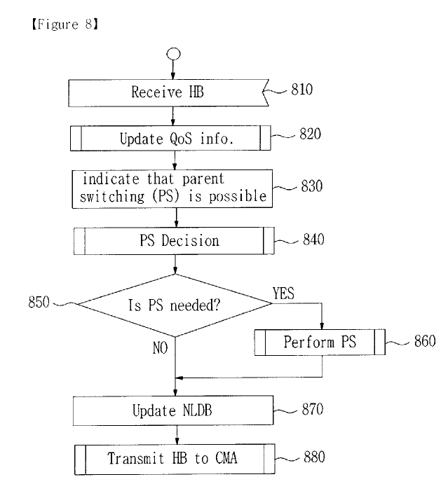

FIG. 5 is a structure of a multicast agent list database (MA_DB), which is managed by the session manager (SM) for membership management according to an embodiment of the present invention. The MA_DB 500 consists of two MA lists, one is an active MA list (AMD 510 of MAs, which have joined the session and probed for aliveness by the SM, and a ready MA list (RML) 520 of MAs, which have requested for the subscription but have not been probed for aliveness by the SM.

The SM periodically probes the MA lists for data integrity of the MA_DB. The SM updates information on the ML, at every predetermined period. In one embodiment, the SM may also arrange the order of MAs in the AML to provide better bootstrapping information to the MAs. Further, the SM updates information on the ready_MA list (RML) at every predetermined period. This updating process includes steps of confirming whether the MA joining the session actually operates in the session and transiting the MA information from the ready_MA_list (RML) to the active_MA_list (AMD in order to deliver the bootstrapping information to the new MAs.

FIG. 6 illustrates a structure of a database (DB) maintained by the MA for membership management according to an embodiment of the present invention. Like the SM, the MAs manage a Neighbor MA List DB (NLDB) 600, in order to keep information on its neighbor MAs. The NLDB 600 may include root path information 610 for storing a path from a root to itself in its belonging tree; a direct node list 620 for storing the information of a parent and children nodes in the tree; a probed neighbor MA list (ProbedNL) 630 where QoS thereof is probed, and a non-probed MA list (NonProbedNL) 640 where QoS thereof is not yet probed.

MAP Discovery (Step 220)

In the map discovery process, the MA discovers the overlay multicast environment. Through the map discovery process, the MA obtains the information on the neighbor Ms in the overlay network environment.

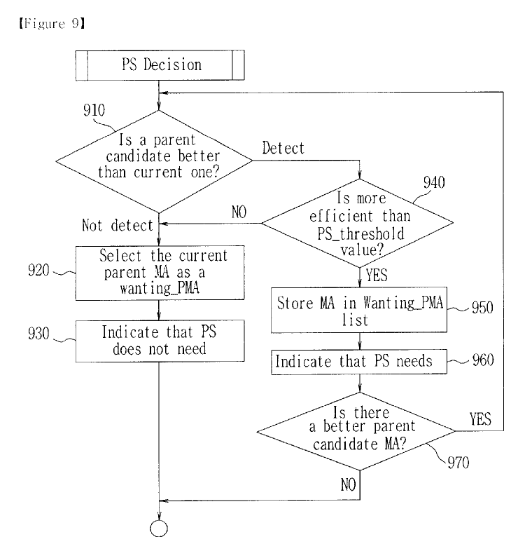

FIG. 7 is a flowchart illustrating the map discovery process according to an embodiment of the present invention. In one embodiment, the MAs perform the map discovery at every certain period. The reason of performing the map discovery is that the neighbor MAs that a certain MA recognizes in the overlay network environment are just only parts of the MAs participating in an entire session. The MA expands its neighbor MA list, thereby selecting a better parent MA in the overlay network. For this, the MA exchanges its neighbor MA list information with the neighbor MAs, thereby performing a MA searching process.

The map discovery process is initiated from Step 710 in which the MA performing the map discovery selects a to-be-probed MA from its neighbor MA list DB (NLDB). The selected MA is a MA in the non-probed MA list stored in the NLDB. The MA prepares a probe request message (ProbeReq) to be transmitted to the selected MA in Step 720. The probe request message includes its neighbor MA information. At this time, The neighbor information may include not only the probed MA information but also the non-probed MA information.

The MA transmits the probe request message (ProbeReq) to the selected MA in Step 730, and receives a probe answer message (ProbeAns) in response to the probe request message (ProbeReq) in Step 740. The probe answer message may include the selected MA's neighbor MA list, as well as the status information of a tree to which the selected MA currently belongs. The status information of the tree refers to information on the path from the root to the selected MA and information on its parent node and its children node.

The MA receives the probe answer message (ProbeAns), and updates its NLDB in Step 750. In other words, the MA stores the information of the selected MA, which has transmitted the probe answer message (ProbeAns). in the probed neighbor MA list (ProbedNL), and adds information on a MA not included in its probed neighbor MA list (ProbedNL), among the neighbor MA list included in the probe answer message (ProbeAns), to its non-probed neighbor MA list (NonProbedNL), thereby performing the update.

Parent Decision (Step 230)

After the map discovery process is completed in Step 220, the MA selects the parent MA from the MAs included in the probed neighbor MA list (ProbedNL), performs the tree attachment process of transmitting a data relay request message (RelayRequest) to the selected parent MA, and receives a relay-request answer message from the parent MA, thereby getting to be in an in_tree state in which the communication is possible. The selection of a parent MA can be accomplished by ordering the MAs included in the probed NL depending on a predetermined session policy, and selecting most optimized MA as the parent MA from the probed NL.

Parent Switching (PS) (Step 250)

According to the present invention, if there is a parent MA better than the current parent MA, the MA can perform parent-switching (PS) operation to improve the tree. However, if two more MAs at the same edge simultaneously perform the PS operation, the structure of a tree may be broken. Therefore, when the MA performs the PS operation, atomicity should be guaranteed.

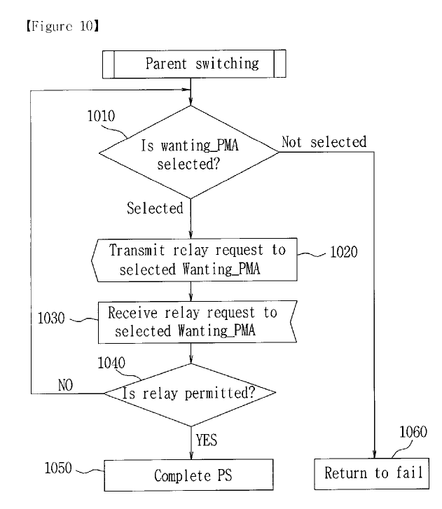

FIG. 8 is a flowchart illustrating a parent switching (PS) process according to an embodiment of the present invention. As shown in FIG. 8, the PS process begins with the receipt of a periodical heart beat (HB) sent from the root in Step 810. The HB includes information on a path from the root to the MA receiving the HB. The MA updates its possible QoS information (e.g., delay, bandwidth, etc.) using the HB in Step 820. A method for updating the QoS information is as follows:

Delay information: at every node that a HB message passes through, delay information is updated by adding a delay value from the root to the upper node, which is provided by the upper node, to a delay value between the upper node and itself.

Bandwidth information: at every node that a HB message passes through, available bandwidth information is updated by selecting a small bandwidth from the minimal bandwidth from the root to the upper node, which is provided by the upper node, and an available bandwidth between the upper node and itself.

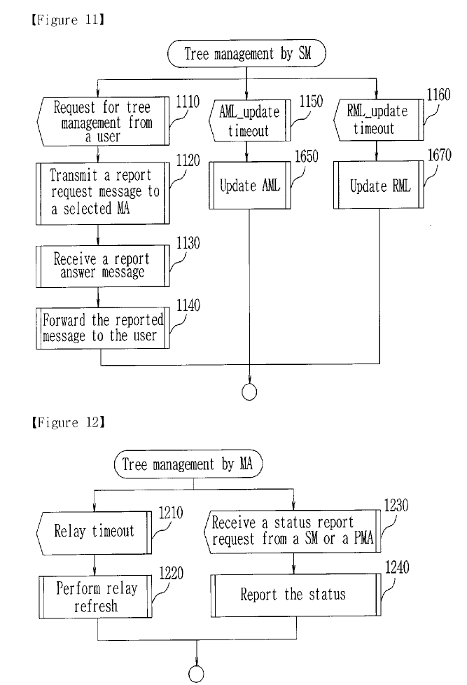

The information will be used to decide a parent MA having a better condition, depending on the session policy. The MA receiving the HB message notifies that it can perform the parent switching in Step 830. Next, the MA determines how much the updated possible QoS information is better than the QoS of its current parent MA (that is, greater than a predetermined threshold value), thereby deciding whether to perform the parent switching (PS) in Step 840. The deciding of whether to perform the PS operation will be later described in a little more detail with reference to FIG. 9.

In Step 850, it is determined whether it is decided to perform the PS operation in the PS decision step in Step 840. If it is determined to perform the PS operation, the MA performs the PS operation in Step 860. A detailed operation of the PS will be later described with reference to FIG. 10.

If it is determined not to perform the PS operation, the MA updates the root path information and the direct NL information stored in its NLDB, using the received HB message in Step 870, and forwards the updated information to its children MA (CMA) in Step 880.

FIG. 9 is a flowchart in more detail illustrating the PS decision step 840 of FIG. 8. As shown in FIG. 9, the decision whether to perform the PS begins with Step 910 of searching for the MA having the better QoS than the current PMA in its probed NL (ProbedNL). If the MA having better QoS is not detected as the search result, the current PMA is selected as a wanting parent MA (wanting_PMA) in Step 920, and an indication that there is no need for PS operation is displayed in Step 930.

If a more efficient MA is detected, it is determined whether the detected MA is excellent over a threshold value (Ps_THRESHOLD) in Step 940. If it is determined not to be excellent, Step 920 is performed. If the MA is detected to be excellent more than the threshold value, the detected MA is selected as the wanting_PMA in Step 950, and indication that there is a need for the PS is displayed in Step 960. It is determined whether there is a better MA to update the wanting_PMA in Step 970. If there is the better MA. Steps 910 to 970 are repeatedly performed.

FIG. 10 is a flowchart illustrating the Parent Switching step 860 of FIG. 8 in more detail. The MA selects a wanting parent MA (wanting_PMA) determined to have the most optimized condition from its probed neighbor MA list (ProbedNL) in Step 1010. Rather than simply selecting the MA having the minimum hop distance, the MA can select a PMA having the most optimized condition under a certain service requirement. For example, in the case of a service sensitive to transmission delay, the hop distance is calculated considering accumulated transmission delay from the root, and in the case of a service sensitive to a bandwidth, the distance between the hops is calculated considering the bandwidth from the root. The MA selecting the wanting_PMA transmits a relay request message (RelayRequest) to the wanting_PMA to request the wanting_PMA to operate as its PEA in Step 1020. Next, the MA receives a relay answer message in response to the relay request message from the wanting_PMA in Step 1030. The wanting_PMA decides whether to permit data relay in consideration of a data relay possibility and a session policy, and transmits the decision result using the relay answer message (Relaying). It is determined whether the PS succeeds or fails based on the relay answer message received from the wanting_PMA in Step 1040. If it is determined to be a success, the PS operation is completed in Step 1050, and otherwise (i.e., if the wanting_PMA rejects the data relay), a failure of the PS is returned in Step 1060.

Periodical Management of Tree Information

Once an overlay multicast session is initiated, it is necessary to manage session status, periodically or upon demand, for session service and membership management. The tree may be managed in a different fashion depending on a session manager (SM) and a multicast agent (MA).

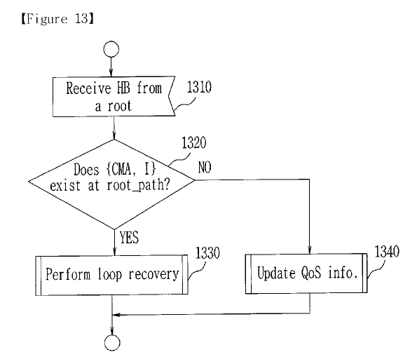

FIG. 11 is an outline diagram illustrating the tree management operation of the SM according to an embodiment of the present invention. In one embodiment, tree management by an SM may be performed mainly where session status should be measured in response to a user's request in Step 1110, where a MA list (AML) in operation should be updated (i.e., when a predetermined time-out for updating the AML arrives) in Step 1150, and where a ready_MA list (RML) should be updated (i.e., when a predetermined time-out for updating the RML arrives) in Step 1160.

When the SM receives a message requesting to manage the tree status from the user in Step 1110, it transmits a report request message requesting desired information to a selected MA in Step 1120, receives a report answer message (Report Answer) from the corresponding MA in Step 1130, and forwards the received report information to the user in Step 1140. By doing so, the user (CP, manager) can obtain information on the session state.

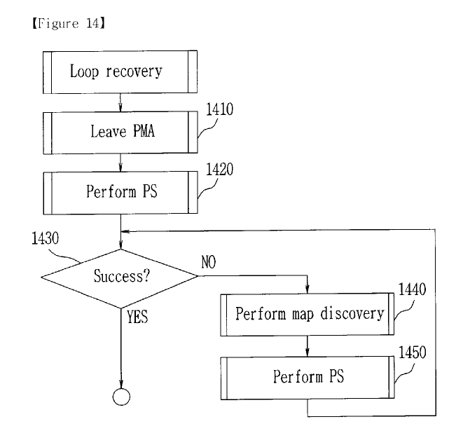

FIG. 12 is an outline diagram illustrating the tree management operation of the multicast agent (MA) according to an embodiment of the present invention. In one embodiment, tree management by the MA may be divided as a process of maintaining the tree and a process of appropriately answering a status report request from the SM or the PMA. For continuous management of the tree, at every relay time-out of Step 1210, the MA performs a relay refreshing process of sending a relay request message (RelayRequest) to its PMA and receiving a relay answer message (Relay Answer) from the PMA in Step 1220. When the MA receives a report request message (Report Request) from the PMA or the SM in Step 1230, it returns a status report answer message to the corresponding PMA or SM in Step 1240.

Error Recovery

Application layer relayed multicast mechanism which uses end hosts as real nodes should keep relayed multicast tree robust in case of error has occurred. The multicast data delivery tree comprised of the MAs should be robust against a variety of errors in light of frequent initiation and termination of personal computer applications and an overlay tree which is different from the topology of a physical network. In the overlay multicast environment, there are two most critical errors which may collapse relayed multicast tree. The one is a loop problem and the other is a network-partitioning problem.

FIG. 13 is an outline diagram illustrating a loop error recovery operation according to an embodiment of the present invention. The loop error can be detected using the HB that is periodically received from the root. As shown in FIG. 13, the MA receives the HB from the root, in Step 1310 and the MA determines whether the MA or its CM is included in a root path i.e., a path from the root to the MA in Step 1310. If so, it is determined that there is a loop and a loop recovery process is performed in Step 1330. Otherwise, the QoS information is updated based on the information contained in the HB in Step 1340. The QoS information is updated by calculating and reflecting the distance from the root.

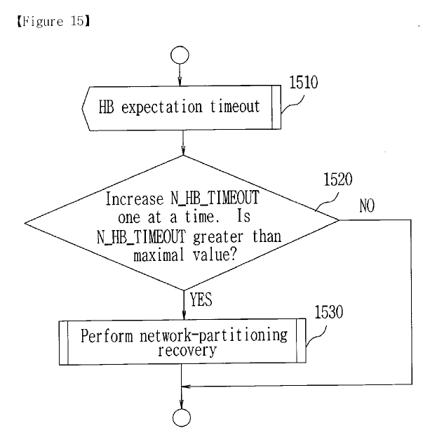

FIG. 14 is a flowchart in detail illustrating the loop recovery operation according to an embodiment of the present invention. The loop recovery-process begins with Step 1410 of leaving from the PM to disconnect the loop. Next, the PS operation is performed to switch to a new PMA in Step 1420. It is determined whether the PS succeeds or fails in Step 1430. If it fails, which indicates that the loop recovery process fails, a new MAP discovery process is performed in Step 1440 and the PS operation is again performed in

Step 1450

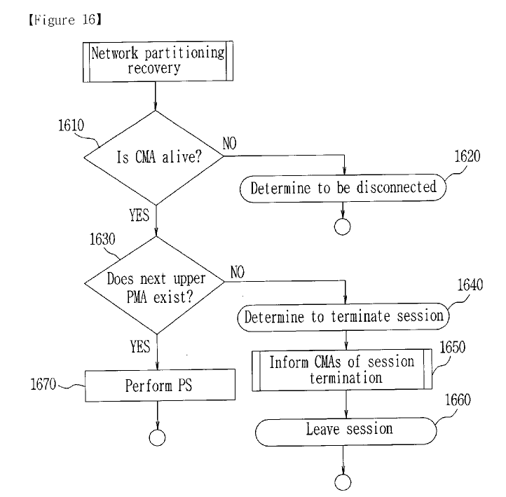

FIG. 15 is an outline diagram illustrating a network-partitioning recovery operation according to an embodiment of the present invention. When the periodical HB is not received within a predefined time (HB expectation time out), it is determined that the network partitioning error occurs in Step 1510. If the HB is not received within the HB expectation lime out, N_HB_TIMEOUT increases one at a time, and it is determined whether N_HB_TIMEOUT is greater than MAX_HB_TIMEOUT in Step 1520. If so, the network partitioning error recovery operation is performed in Step 1530.

FIG. 16 is a flowchart in detail illustrating the network-partitioning recovery operation according to an embodiment of the present invention. In order to confirm whether only an upstream is disconnected, the MA determines whether its child MA (CMA) operates in Step 1610. When the CMA is also disconnected, the MA determines that only the MA exists alone in the network in Step 1620. If it is determined that the CMA operates, the MA confirms whether any of the next upper parent MAs (PMAs) is alive through its root path in Step 1630. If any of the next upper PMAs does not operate, the MA determines that the session is terminated in Step 1640, transmits a leave request message (LeaveRequest) to its CMAs in Step 1650, and leaves the session in Step 1660. If any of the next upper PMAs operates, the PS operation is performed in Step 1670.

The bootstrapping, MP discovery, parent switching, periodical tree management and error recovery processes required to configure and manage the overlay multicast tree according to the preferred embodiment of the present invention have been described by function with reference to the system block diagrams and the flowcharts. The present invention is capable of effectively configuring and managing the overlay multicast tree through the method and/or the system including a possible combination of the above processes.

As understood by those skilled in the art, the method, the system, or the computer readable recording media can be provided as embodiments of the present invention. Accordingly, the present invention can be entirely embodied by hardware, software, or a combination thereof. Further, the present invention may be a computer readable recording media (including a disk storage unit, a CD-ROM, and an optic storage unit, to which the present invention is not limited) having a built-in computer accessible program code, available to a computer.

1. A method for configuring and managing an overlay multicast data delivery tree in a transmission network including a session manager (SM) and at least one multicast agent (MA), the method comprising the steps of:
at the MA intending to joining a session,
(a) obtaining an active neighbor MA list from the SM;
(b) detecting information on QoS information of each neighbor MA in the active neighbor MA list;
(c) selecting a MA having the most optimized QoS as a parent MA based on the QoS information of each neighbor MA in the active neighbor MA list:
(d) joining an overlay multicast data communication session through the selected parent MA;
(e) periodically receiving HB(heart beat) information having information on a path from a root to the MA, and determining whether to perform a parent-switching based on the HB information; and
(f) parent-switching from the current parent MA to a MA having a better QoS when it is determined to perform the parent-switching.

2. The method according to claim 1, wherein said step (a) comprises the sub-steps of:
(a1) transmitting a subscription request message to the SM by the MA intending to joining an overlay multicast data transmission session: and
(a2) receiving a subscription answer message containing the active neighbor MA list from the SM.

3. The method according to claim 1, wherein the MA stores root path information on a path from the root to the MA in its belonging overlay multicast data delivery tree: parent MA and child MA information in the tree; a probed neighbor MA list storing at least one probed MA; and a non-probed neighbor MA list storing at least one non-probed MA.

4. The method according to claim 3, wherein said step (b) comprises the sub-steps of:
(b1) storing the active neighbor MA list in its non-probed neighbor MA list;
(b2) selecting a to-be-probed MA from its non-probed neighbor MA list;
(b3) transmitting a probe request message containing its neighbor MA list, to the to-be-probed MA;
(b4) receiving a probe answer message containing neighbor MA list of the to-be-probed MA, from the to-be-probed MA;
(b5) adding the to-be-probed MA information to its probed neighbor MA list; and
(b6) adding MA information, which is included in the neighbor MA list of the to-be-probed MA, but not included in its probed neighbor MA list, to its non-probed MA list.

5. The method according to claim 3, wherein said step (b) is periodically performed.

6. The method according to claim 1, wherein in said step (c), the MA having the most optimized QoS information is decided depending on a specific service requirement.

7. The method according to claim 1, wherein said step (d) comprises the sub-steps of:
(d1) transmitting a data relay request message to the parent MA;
(d2) receiving a data relay answer message having data relay permission or rejection, from the parent MA; and
(d3) determining the data relay permission or rejection based on the data relay answer message,
wherein when the data relay answer message represents the data relay rejection, a MA having next better QoS is selected as the parent MA and the sub-steps of (d1) to (d3) are repeated.

8. The method according to claim 1, wherein said step (e) comprises the sub-steps of:
(e1) calculating possible QoS information using the HB information;
(e2) comparing the possible QoS information with QoS information of the current parent MA, and determining whether the possible QoS is better than that of the current parent MA and is over a predetermined threshold;
(e3) when it is determined that the possible QoS is better than that of the current parent MA and is over the predetermined threshold, deciding that the parent-switching is needed: and
(e4) otherwise, deciding that the parent-switching is not needed.

9. The method according to claim 1, wherein said step (f) comprises the sub-steps of:
(f1) selecting a MA having the most optimized QoS as a parent MA, among the neighbor MAs:
(f2) transmitting a data relay request message to the parent MA;
(f3) receiving a data relay answer message having data relay permission or rejection, from the parent MA;
(f4) determining the data relay permission or rejection, based on the data relay answer message; and
(f5) when the data relay answer message represents the data relay rejection, selecting a MA having next optimized QoS, and repeating the sub-steps of (f2) to (f5).

10. The method according to claim 1, further comprising the steps of, at the MA, transmitting a relay request message to the parent MA, at regular intervals, and receiving a relay answer message from the parent MA.

11. The method according to claim 1, further comprising the step of determining that a loop error occurs in the session, when the MA redundantly exists or a child MA of the MA exists in the path from the root to the MA, which is included in the periodically received HB information.

12. The method according to claim 11, further comprising the step of perform the parent-switching, when the loop error occurs.

13. The method according to claim 1, further comprising the step of determining that a network-partitioning error occurs, when the periodically received HB information is not received within a predetermined time.

14. The method according to claim 13, further comprising the steps of when the network partitioning error occurs,
i) checking whether a child MA is alive or not:
ii) when it is checked that the child MAs is not alive, determining that disconnection occurs in the network; and
iii) when it is checked that the child MA is alive,
checking if a next upper parent MA is alive or not,
when the next upper parent MA is alive, perform the parent-switching to the next upper parent MA, and
when the next upper parent MA is not alive, determining that the session is terminated, transmitting a leave request message to the child MA, and leaving the session.

15. A method for configuring and managing an overlay multicast data delivery tree in a transmission network having a session manager (SM) and at least one multicast agent (MA), the method comprising the steps of: at the SM,
storing a list of active MAs having joined a session managed by the SM and being currently in a normal operation, and a list of ready MAs not yet confirmed whether to normally operate in the session;
receiving a subscription request message from a MA intending to joining the session;
determining whether to permit subscription of the MA, in response to the received subscription request message;
when it is determined that session subscription is permitted, extracting a portion of the active MA list, and transmitting a subscription answer message having the extracted portion of the active MA list to the MA;
when it is determined that the session subscription is rejected,
transmitting a subscription answer message having a rejection reason to the MA; and
adding the MA information to the ready MA list.

16. The method according to claim 15, further comprising the step of, a1 the SM, checking session status in response to a user request.

17. The method according to claim 16, wherein the step of checking the session status comprises the sub-steps of: at the SM,
receiving from the user a message of asking the status of a specific MA;
transmitting a status report request message to the specific MA;
receiving a report answer message from the specific MA; and
forwarding the received report answer message to the user.

18. The method according to claim 15, further comprising the steps of: at the SM,
periodically updating the active MA list at first periods; and
periodically updating the ready MA list at second periods.

19. A computer readable recording media recording a computer program for performing a method for configuring and managing an overlay multicast data delivery tree according to any one of claims 1 to 18.

20. A multicast agent apparatus comprising:
means for obtaining an active neighbor MA list from a SM;
means for detecting QoS information of each neighbor MA in the active neighbor MA list;
means for selecting a MA having the most optimized QoS as a parent MA based on the QoS information of each the neighbor MA, and joining an overlay multicast data communication session through the selected parent MA;
means for periodically receiving HB information having information on a path from a root to the MA, and determining whether to perform a parent switching based on the received HB information; and
means for parent-switching from the current parent MA to a MA having a better QoS when it is determined to perform the parent-switching.

21. A session manager apparatus comprising:
means for storing a list of active MAs having joined a session managed by itself and being currently in a normal operation, and a list of ready MAs not yet confirmed whether normally operating in the session, and periodically updating the lists;
means for receiving a subscription request message from a MA intending to joining the session, and determining whether permitting subscription of the MA in response to the subscription request message;
means for extracting a portion of the active MA list and transmitting to the MA a subscription answer message having the extracted portion of the active MA list, when it is determined to permit session subscription, and transmitting to the MA a subscription answer message having a rejection reason, when it is determined to reject the session subscription; and
means for adding the MA information to the ready MA list.

1. A method for configuring and managing an overlay multicast data delivery tree in a transmission network including a session manager (SM) and at least one multicast agent (MA), the method comprising the steps of:
at the MA intending to joining a session,
(a) obtaining an active neighbor MA list from the SM;
(b) detecting information on QoS information of each neighbor MA in the active neighbor MA list;
(c) selecting a MA having the most optimized QoS as a parent MA based on the QoS information of each neighbor MA in the active neighbor MA list:
(d) joining an overlay multicast data communication session through the selected parent MA:
(e) periodically receiving HB(heart beat) information having information on a path from a root to the MA, and determining whether to perform a parent-switching based on the HB information; and
(f) parent-switching from the current parent MA to a MA having a better QoS when it is determined to perform the parent-switching.

2. The method according to claim 1, wherein said step (a) comprises the sub-steps of:
(a1) transmitting a subscription request message to the SM by the MA intending to joining an overlay multicast data transmission session; and
(a2) receiving a subscription answer message containing the active neighbor MA list from the SM.

3. The method according to claim 1, wherein the MA stores root path information on a path from the root to the MA in its belonging overlay multicast data delivery tree: parent MA and child MA information in the tree; a probed neighbor MA list storing at least one probed MA; and a non-probe; neighbor MA list storing at least one non-probed MA.

4. The method according to claim 3, wherein said step (b) comprises the sub-steps of:
(b1) storing the active neighbor MA list in its non-probed neighbor MA list;
(b2) selecting a to-be-probed MA from its non-probed neighbor MA list;
(b3) transmitting a probe request message containing its neighbor MA list, to the to-be-probed MA;
(b4) receiving a probe answer message containing neighbor MA list of the to-be-probed MA, from the to-be-probed MA;
(b5) adding the to-be-probed MA information to its probed neighbor MA list; and
(b6) adding MA information, which is included in the neighbor MA list of the to-be-probed MA, but not included in its probed neighbor MA list, to its non-probed MA list.

5. The method according to claim 3, wherein said step (b) is periodically performed.

6. The method according to claim 1, wherein in said step (c), the MA having the most optimized QoS information is decided depending on a specific service requirement.

7. The method according to claim 1, wherein said step (d) comprises the sub-steps of:
(d1) transmitting a data relay request message to the parent MA;
(d2) receiving a data relay answer message having data relay permission or rejection, from the parent MA; and
(d3) determining the data relay permission or rejection based on the data relay answer message,
wherein when the data relay answer message represents the data relay rejection, a MA having next better QoS is selected as the parent MA and the sub-steps of (d1) to (d3) are repeated.

8. The method according to claim 1, wherein said step (e) comprises the sub-steps of:
(e1) calculating possible QoS information using the HB information;
(e2) comparing the possible QoS information with QoS information of the current parent MA, and determining whether the possible QoS is better than that of the current parent MA and is over a predetermined threshold;
(e3) when it is determined that the possible QoS is better than that of the current parent MA and is over the predetermined threshold, deciding that the parent-switching is needed; and
(e4) otherwise, deciding that the parent-switching is not needed.

9. The method according to claim 1, wherein said step (f) comprises the sub-steps of:
(f1) selecting a MA having the most optimized QoS as a parent MA, among the neighbor MAs:
(f2) transmitting a data relay request message to the parent MA;
(f3) receiving a data relay answer message having data relay permission or rejection, from the parent MA;
(f4) determining the data relay permission or rejection, based on the data relay answer message; and
(f5) when the data relay answer message represents the data relay rejection, selecting a MA having next optimized QoS, and repeating the sub-steps of (f2) to (f5).

10. The method according to claim 1, further comprising the steps of, at the MA, transmitting a relay request message to the parent MA, at regular intervals, and receiving a relay answer message from the parent MA.

11. The method according to claim 1, further comprising the step of determining that a loop error occurs in the session, when the MA redundantly exists or a child MA of the MA exists in the path from the root to the MA, which is included in the periodically received HB information.

12. The method according to claim 11, further comprising the step of perform the parent-switching, when the loop error occurs.

13. The method according to claim 1, further comprising the step of determining that a network-partitioning error occurs, when the periodically received HB information is not received within a predetermined time.

14. The method according to claim 13, further comprising the steps of when the network partitioning error occurs,
i) checking whether a child MA is alive or not:
ii) when it is checked that the child MAs is not alive, determining that disconnection occurs in the network; and
iii) when it is checked that the child MA is alive,
checking if a next upper parent MA is alive or not,
when the next upper parent MA is alive, perform the parent-switching to the next upper parent MA, and
when the next upper parent MA is not alive, determining that the session is terminated, transmitting a leave request message to the child MA, and leaving the session.

15. A method for configuring and managing an overlay multicast data delivery tree in a transmission network having a session manager (SM) and at least one multicast agent (MA), the method comprising the steps of: at the SM,
storing a list of active MAs having joined a session managed by the SM and being currently in a normal operation, and a list of ready MAs not yet confirmed whether to normally operate in the session;
receiving a subscription request message from a MA intending to joining the session;
determining whether to permit subscription of the MA, in response to the received subscription request message;
when it is determined that session subscription is permitted, extracting a portion of the active MA list, and transmitting a subscription answer message having the extracted portion of the active MA list to the MA;
when it is determined that the session subscription is rejected, transmitting a subscription answer message having a rejection reason to the MA; and
adding the MA information to the ready MA list.

16. The method according to claim 15, further comprising the step of, a1 the SM, checking session status in response to a user request.

17. The method according to claim 16, wherein the step of checking the session status comprises the sub-steps of: at the SM,
receiving from the user a message of asking the status of a specific MA;
transmitting a status report request message to the specific MA;
receiving a report answer message from the specific MA; and
forwarding the received report answer message to the user.

13. The method according to claim 15, further comprising the steps of: at the SM,
periodically updating the active MA list at first periods; and
periodically updating the ready MA list at second periods.

19. A computer readable recording media recording a computer program for performing a method for configuring and managing an overlay multicast data delivery tree according to any one of claims 1 to 18.

20. A multicast agent apparatus comprising:
means for obtaining an active neighbor MA list from a SM;
means for detecting QoS information of each neighbor MA in the active neighbor MA list;
means for selecting a MA having the most optimized QoS as a parent MA based on the QoS information of each the neighbor MA, and joining an overlay multicast data communication session through the selected parent MA;
means for periodically receiving HB information having information on a path from a root to the MA, and determining whether to perform a parent switching based on the received HB information; and
means for parent-switching from the current parent MA to a MA having a better QoS when it is determined to perform the parent-switching.

21. A session manager apparatus comprising:
means for storing a list of active MAs having joined a session managed by itself and being currently in a normal operation, and a list of ready MAs not yet confirmed whether normally operating in the session, and periodically updating the lists;
means for receiving a subscription request message from a MA intending to joining the session, and determining whether permitting subscription of the MA in response to the subscription request message;
means for extracting a portion of the active MA list and transmitting to the MA a subscription answer message having the extracted portion of the active MA list, when it is determined to permit session subscription, and transmitting to the MA a subscription answer message having a rejection reason, when it is determined to reject the session subscription; and
means for adding the MA information to the ready MA list.
